(19) United States
(12) Patent Application Publication
(10) Pub. No.: US 2026/0104203 A1
(43) Pub. Date: Apr. 16, 2026

(54) SELF-CLEANING SPRAY COOLING SYSTEM FOR A METALLURGICAL FURNACE

(71) Applicant: Systems Spray-Cooled LLC., Smyrna, TN (US)

(72) Inventors: Eric CHODL, Smyrna, TN (US); Scott A. FERGUSON, Murfreesboro, TN (US); Cameron NOLEN, Smyra, TN (US)

(21) Appl. No.: 18/916,500

(22) Filed: Oct. 15, 2024

(51) Int. Cl. F27B 3/24; B05B 15/52; F27B 3/08; F27B 3/16

(52) U.S. Cl. CPC F27B 3/24; B05B 15/52; F27B 3/085; F27B 3/16; F27B 2003/165

(57) ABSTRACT

A spray cooling system having a cleanout trap for use in a sidewall or roof of a metallurgical furnace is disclosed herein. The spray cooling system has a header fluidly coupled to a coolant source, a spray conduit fluidly coupled to the header for receiving coolant flowing from the header and one or more nozzles fluidly coupled to spray conduits. The nozzles are configured to receive coolant from the spray conduit and spray, mist or otherwise direct the coolant from spray conduit onto a surface of the sidewall or roof for cooling. The spray cooing system has a cleanout trap fluidly coupled thereto. The cleanout trap is configured to remove particulate from the coolant flowing through the cleanout trap prior to the coolant flowing through the nozzles.

### BACKGROUND OF THE DISCLOSURE

### Field of the Disclosure

Embodiments of the present disclosure relates generally to a spray cooling system for a metallurgical furnace and the like, and more particularly to a self-cleaning feature of the spray cooling system.

### Description of the Related Art

Metallurgical furnaces (e.g., an electric arc furnace or a ladle metallurgical furnace) are used in the processing of molten metal materials. The electric arc furnace heats charged metal in the furnace by means of an electric arc from a graphite electrode. The electric current from the electrode passes through the charged metal material forming a molten bath of the metal materials. The furnaces house the molten materials during the processing of the molten materials forming molten steel and slag (a stony waste material).

A metallurgical furnace as above described is typically made of steel, aluminum, aluminum base alloys, copper, copper base alloys, and metals having similar thermal characteristics. The surfaces of the sidewall and roof exposed to the molten material in the furnace become very hot during the processing of the molten materials. To dissipate heat from the furnace sidewalls and roof exposed to the molten materials, the metallurgical furnace may have cooling systems. One type of cooling system is a spray cooling system. The spray cooling system sprays water on the hot surfaces in the interior portion of the sidewall and/or the roof of the furnace. The sprayed water is then collected in a drain and pumped from the sidewall and/or roof. However, after continued operation, the water used in the spray cooling system may deposit solids inside the spray cooling system which precipitated out of the water. The deposits may collect in the spray cooling system and clog valves, spray nozzles, and/or other features of the spray cooling system such as entire spray bars. Conventionally, the metallurgical furnace must be taken offline to clean the deposits and clogs from the spray cooling system to ensure the metallurgical furnace is properly cooled. However, the cleaning of the deposits from the spray cooling system takes considerable time as the whole system must be properly cleaned prior to bringing the metallurgical furnace back online.

Therefore, there is a need for an improved cooling system for metallurgical furnaces.

### SUMMARY

A spray cooling system having a cleanout trap for use in a sidewall or roof of a metallurgical furnace is disclosed herein. In a first example, a spray cooling system has a header fluidly coupled to a coolant source, a spray conduit fluidly coupled to the header for receiving coolant flowing from the header and one or more nozzles fluidly coupled to spray conduits. The nozzles are configured to receive coolant from the spray conduit and spray, mist, flow, or otherwise direct the coolant from spray conduit onto a surface of the sidewall or roof for cooling. The spray cooing system has a cleanout trap fluidly coupled thereto. The cleanout trap is configured to remove particulate from the coolant flowing through the cleanout trap prior to the coolant flowing through the nozzles.

In another example, a sidewall for a metallurgical furnace is disclosed. The sidewall has a cover plate and hot plate coupled in a spaced apart relation to the cover plate forming an inner volume of the sidewall. The hot plate is configured to contact molten material. A spray cooling system is disposed in the inner volume of the sidewall and configured to deliver coolant on to the hot plate. The spray cooling system has a header fluidly coupled to a coolant source and a spray conduit fluidly coupled to the header for receiving coolant flowing from the header. One or more nozzles are fluidly coupled to the spray conduits. The nozzles are configured to receive coolant from the spray conduit and spray, mist, flow, or otherwise direct the coolant from spray conduit onto the hot plate for cooling. A cleanout trap is fluidly coupled to the spray cooling system. The cleanout trap is configured to remove particulate from the coolant flowing through the cleanout trap prior to the coolant flowing through the nozzles.

In another example, a roof for a metallurgical furnace is provided. The roof has a cover plate and a hot plate coupled in a spaced apart relation to the cover plate forming an inner volume of the roof, the hot plate configured to face the inner volume. A spray cooling system disposed in the inner volume of the roof and configured to deliver coolant on to the hot plate. The spray cooling system has a header fluidly coupled to a coolant source, a spray conduit fluidly coupled to the header for receiving coolant flowing from the header and one or more nozzles fluidly coupled to spray conduits. The nozzles are configured to receive coolant from the spray conduit and spray, mist, flow, or otherwise direct the coolant from the spray conduit on to the hot plate for cooling. A cleanout trap is fluidly coupled to the spray cooling system. The cleanout trap is configured to alter the flow of the coolant in a manner that promotes particulate to drop out from the coolant flowing through the cleanout trap prior to the coolant flowing through the nozzles.

### BRIEF DESCRIPTION OF THE DRAWINGS

So that the way the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a side elevation view of a metallurgical furnace having a spray cooling system with a cleanout trap.

FIG. 2 illustrates a partial sectional view the sidewall of the metallurgical furnace of FIG. 1.

FIG. 3 illustrates a partial sectional view of the roof of the metallurgical furnace of FIG. 1.

FIG. 4A illustrates a portion of a spray cooling system shown having a cleanout trap.

FIG. 4B illustrates a portion of a spray cooling system shown having another example of the cleanout trap.

FIG. 4C illustrates a portion of a spray cooling system shown having yet another example of the cleanout trap.

FIG. 5A-5C illustrate other portions of the spray cooling system illustrating locations of the cleanout trap.

FIG. 6 illustrates a method for removing particulate from a spray cooling system.

To facilitate understanding, identical reference numerals have been used, where possible, to designate identical elements that are common to the figures. It is contemplated that elements disclosed in one embodiment may be beneficially utilized with other embodiments without specific recitation.

### DETAILED DESCRIPTION

The present invention is directed to a metallurgical furnace having a spray cooling system configured with a cleanout trap to enhance spray cooling of the sidewall and/or roof. For example, the spray cooling system may be disposed in the sidewall, roof, elbows, ducts or other cooled surfaces of the metallurgical furnace. For example, the sidewall and roof of the metallurgical furnace includes a spray-cooled hot plate having an inner surface that faces an interior volume of the furnace. The spray cooling system is provided with a cleanout trap for removing particulate from the cooling fluid (e.g., coolant), thus substantially preventing clogging of components of the spray cooling system with particulate that may be entrained with the cooling fluid. The cleanout trap may be manually or automatically operated. In some examples, the cleanout trap utilizes eddy flow and geometries selected to create low pressure zones that promote particulate to fall out of the flow of coolant within the spray cooling system. Accumulated particulate is periodically flushed or otherwise removed from cleanout trap. Thus, the cleanout trap improves cooling performance of the spray cooling system and additionally reduces significant downtime of the metallurgical furnace for the removal of clogs and precipitated solids out of the spray cooling system.

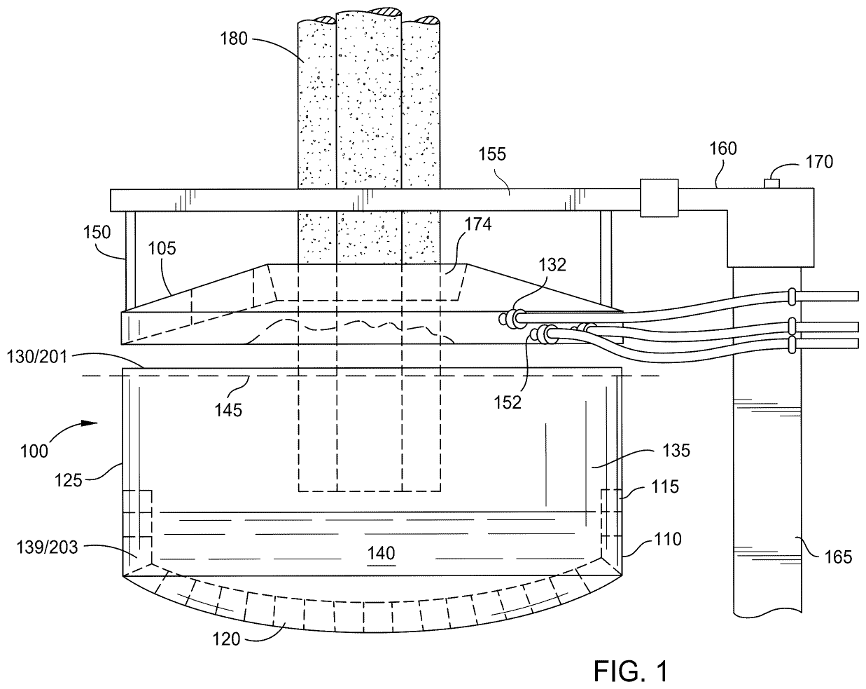

FIG. 1 illustrates a side elevation view of a metallurgical furnace 100 having a roof 105 removably disposed on a furnace body 110. The furnace body 110 includes a sidewall 125 disposed on a hearth 115. The hearth 115 is lined with refractory brick 120. One or both of the roof 105 and sidewall 125 may be spray-cooled, as further described below, with a spray cooling system that includes a particulate trap. The sidewall 125 has a top 130 and a bottom 139. The roof 105 is moveably disposed on the top 130 of the sidewall 125. The roof 105 and furnace body 110 enclose an interior volume 135 of the metallurgical furnace 100. The interior volume 135 may be loaded or charged with molten material 140, e.g., metal, scrap metal, or other meltable material, which is to be melted within the metallurgical furnace 100.

The metallurgical furnace 100, including the furnace body 110 and the spray-cooled roof 105, is rotatable along a tilt axis 145. The metallurgical furnace 100 may be tilted in a first direction about the tilt axis 145 toward the slag door (not shown) multiple times during a single batch melting process, sometimes referred to as a “heat”, to remove slag. Similarly, the metallurgical furnace 100 may be tilted in a second direction about the tilt axis 145 towards a tap spout (not shown) multiple times during a single batch melting process including one final time to remove the molten material 140.

Roof lift members 150 may be attached at a first end to the roof 105. The roof lift members 150 may be chains, cables, ridged supports, or other suitable mechanisms for supporting the roof 105. The roof lift members 150 may be attached at a second end to one or more mast arms 155. The mast arms 155 extend horizontally and spread outward from a mast support 160. The mast support 160 may be supported by a mast post 165. A coupling 170 may attach the mast post 165 to the mast support 160. The mast support 160 may rotate about the coupling 170 and the mast post 165. Alternately, the mast post 165 may rotate with the mast support 160 for moving the roof lift members 150. In yet other examples, roof lift members 150 may be aerially supported to move the roof 105. In one embodiment, the roof 105 is configured to swing or lift away from the sidewall 125. The roof 105 is lifted away from the sidewall 125 to expose the interior volume 135 of the metallurgical furnace 100 through the top 130 of the sidewall 125 for loading material therein.

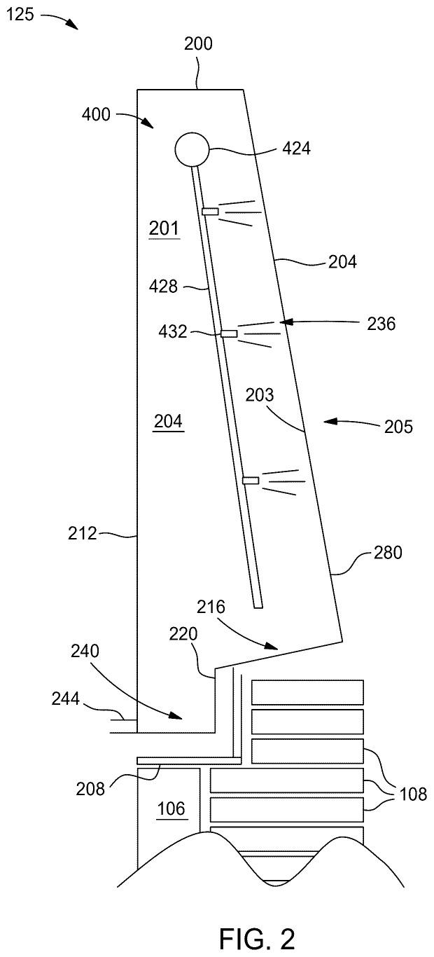

At least the sidewall 125 of the furnace body 110 may be ring, oval, or circular-shaped when viewed from a top plan view, of which a portion is shown in FIG. 2. Likewise, the roof 105 has a shape complimentary to that of the sidewall 125 so that the interior volume 135 may be enclosed.

A central opening 175 may be formed through the roof 105. Electrodes 180 extend through the central opening 175 from a position above the roof 105 into the interior volume 135. During operation of the metallurgical furnace 100, the electrodes 180 are lowered through the central opening 175 into the interior volume 135 of the metallurgical furnace 100 to provide electric arc-generated heat to melt the material 140.

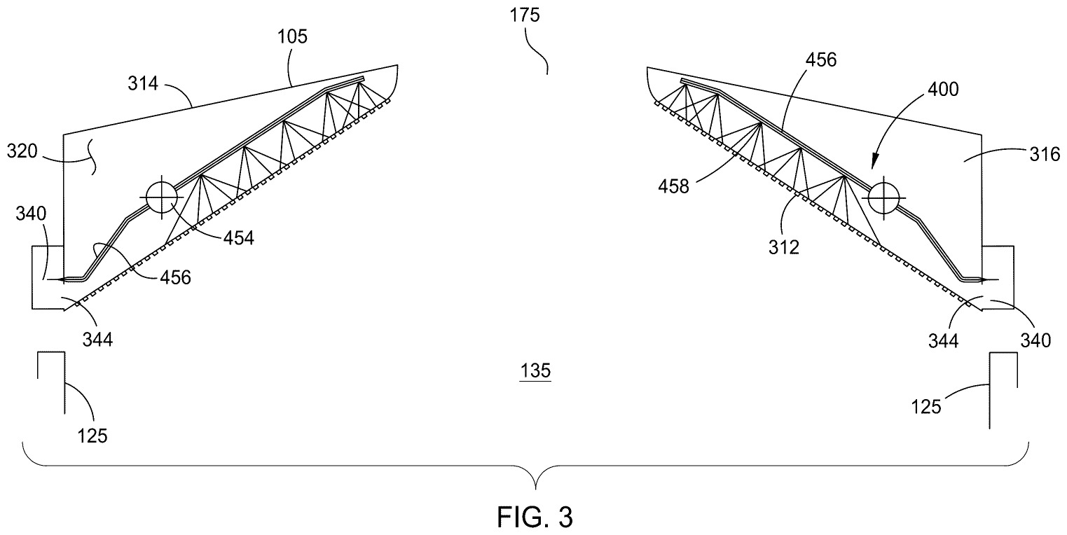

The roof 105 may be coupled to a coolant supply 132 and one or more coolant drains 152. The coolant supply 132 may provide coolant to the roof 105. The coolant drains 152 may remove the spent coolant from the roof 105. The roof 105 may further include an exhaust port to permit removal of fumes generated within the interior volume 135 of the metallurgical furnace 100 during operation. The sidewall 125 and the roof 105 will be discussed further below with respect to FIGS. 2 and 3 respectively.

FIG. 2 illustrates a partial sectional view of the sidewall 125 of the metallurgical furnace 100 of FIG. 1. The sidewall 125 includes an upper wall 200, an inner wall 204, a bottom wall 208, and an outer wall 212. The upper wall 200, the inner wall 204, the bottom wall 208, and the outer wall 212 surround and define an interior volume 201 of the sidewall 125. The inner wall 204 of the sidewall 125 also includes a hot plate 280, a return wall 216 and a lower wall 220. The return wall 216 and the lower wall 220 connect the hot plate 280 to the bottom wall 208 in a manner that forms a catch basin or a drain trough 240 in the sidewall 125.

An inner surface 203 (e.g., cool face) of the hot plate 280 faces the interior volume 201. An outer surface 205 (e.g., hot face) of the hot plate 280 is opposite the inner surface 203 and faces the electrodes 136 disposed in the interior of the furnace 100. As such, the outer surface 205 of the inner wall 204 faces the opening 101.

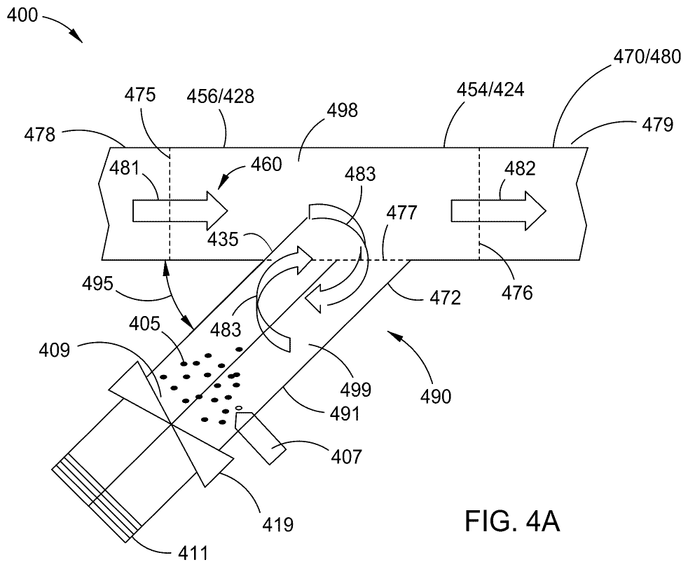

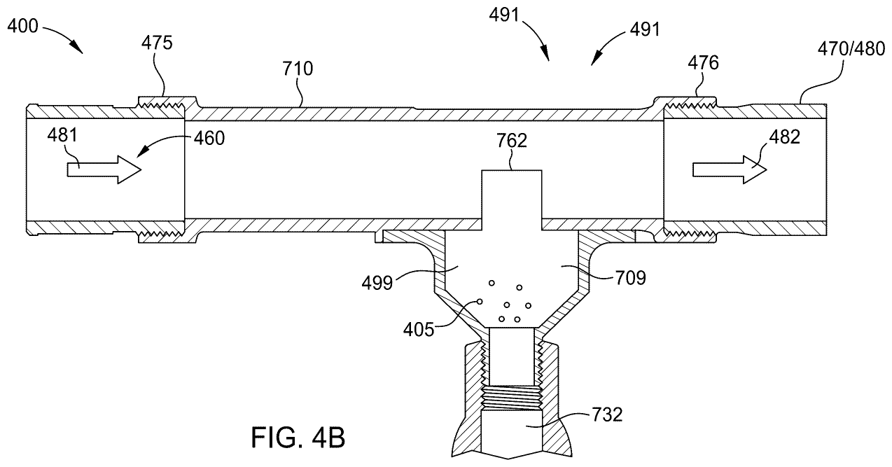

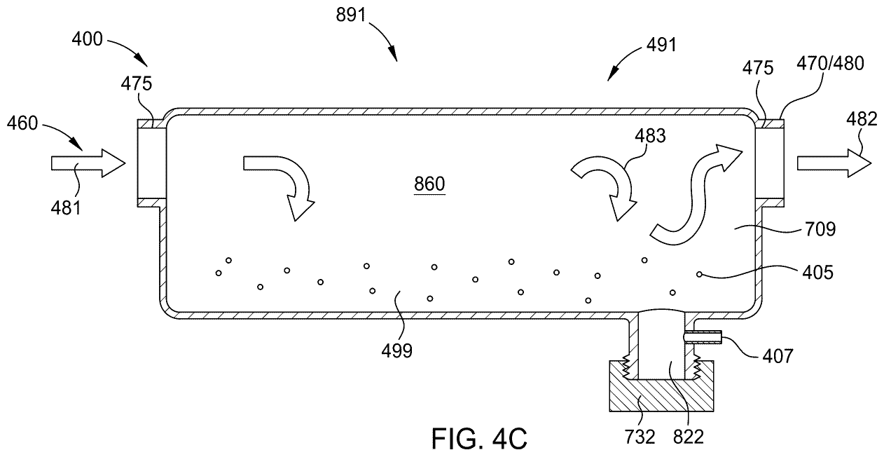

As briefly described above, one or both of the roof 105 and sidewall 125 is cooled a spray cooling system that includes a particulate trap. In the example depicted in FIG. 2, the sidewall 125 includes a spray cooling system 400 disposed in the interior volume 201 of the sidewall 125. The spray cooling system 400 is equipped with a cleanout trap, which will be discussed further below with respect to FIGS. 4-6. The interior volume 201 is sufficiently voluminous to enable access from inside the sidewall 125 of the spray cooling system 400. Advantageously, the sidewall 125 enables inspection and maintenance of the spray cooling system 400 to be simplified, enabling personnel to perform routine maintenance from within the sidewall 125 without the limited visibility of restrictive maintenance hatches, or the need to disassemble the sidewall 125 to inspect internal components.

The spray cooling system 400 includes a sidewall header pipe 424, a plurality of sidewall branch conduits 428 coupled to the sidewall header pipe 424, and an array of spray sidewall nozzles 432 coupled to the sidewall branch conduits 428. The sidewall header pipe 424 is coupled to the input cooling port. The sidewall header pipe 424 is generally located at or near the upper wall 200 within interior volume 201. The sidewall branch conduits 428 extend downward from the sidewall header pipe 424. In one example, the sidewall branch conduits 428 extend downward in a non-vertical orientation from the sidewall header pipe 424 such that the distal end of the sidewall branch conduits 428 is farther from the outer wall 212 than the end of the branch conduit 428 that is coupled to the sidewall header pipe 424. Advantageously, the non-vertical orientation of the branch conduit 428 provides more space for servicing within the interior volume 201. In this example, the branch conduit 428 maintains a substantially constant distance from the hot plate 280. Although only one branch conduit 428 is shown in the sectional view of FIG. 2, it is to be appreciated that the sidewall branch conduits 428 are distributed around the interior volume 201 of the sidewall 125 such that coolant may be supplied to essentially the entire cool face of the hot plate 280, and optionally, other portions of the inner wall 204.

Each sidewall nozzle 432 is coupled to the branch conduit 428. A cooling fluid is delivered from the sidewall nozzles 432 onto the cool face of the hot plate 280. The cooling fluid is one example of the coolant introduced into the interior volume 201 through the input cooling port 117, shown in FIG. 1. The nozzle 432 may spray, mist, drip, flow, or otherwise direct the coolant from the branch conduit 428 onto the inner surface 203 of the hot plate 280 for cooling the hot plate 280. In one example, the cooling fluid is sprayed or flowed out from the nozzles 432 on to inner surface 203 of the hot plate 280. Cooling fluid then runs down the inner surface 203 to the return wall 216, from which the spent coolant is collected and removed from the sidewall 125. In one example, the spent cooling fluid is directed from the inner surface 203 to the return wall 216 to the drain trough 240 extending below the end of the return wall 216.

The drain manifold 340 is connecting to a channel 344 in the external wall 316. The channel 344 is coupled to the drain port 119 of the cooling system 121. The channel 244 provides a path for the cooling fluid to flow out from the drain manifold 340 of the sidewall 125 and into the drain port so that spent coolant may be removed from the sidewall 125.

Additionally or in the alternative, spray cooling system may also be provided to improve cooling of the roof 105 of FIG. 1. FIG. 3 illustrates a cross section for a roof 105 of FIG. 1. The roof 105 has an inner plate 312, an outer plate 314, and an external wall 316. The inner plate 312, the outer plate 314, and the external wall 316 surround and define an enclosed space 320. The inner plate 312 has an inner surface that is exposed to the interior volume 135 of the metallurgical furnace 100. The enclosed space 320 additionally includes the spray cooling system 400 to prevent excessive heat buildup in the inner plate 312 of the roof 105. The spray cooling system 400 disposed in the roof 105 is also equipped with a cleanout trap, which will be discussed further below with respect to FIGS. 4-6.

The inner plate 312 may be shaped to slope downwardly from the central opening 124 to facilitate the removal of spent coolant from the inner plate 312 into a drain manifold 340. For example, the inner plate 312 may be frusto-conical in shape and spent coolant may drain outwardly and flow into the drain manifold 340 via an opening 342 in the external wall 316.

The drain manifold 340 may be a substantially closed channel made of, for example, rectangular cross section tubing. The drain manifold 340 may extend around the entire periphery of the roof 105. The drain manifold 340 may be located outside of the enclosed space, for example, circumscribing the external wall 316.

The spray cooling system 400 disposed in the enclosed space 320 is used to prevent excessive heat buildup in the inner plate 312 of the roof 105. The spray cooling system 400 is substantially similar as disclosed in the sidewall 125. The spray cooling system 400 utilizes a fluid based coolant, such as water or some other suitable liquid.

The spray cooling system 400 in the roof 105 includes a roof header 454, and a plurality of roof spray conduits 456. Each roof spray conduit 456 may include one or more roof spray nozzles 458 configured to disperse coolant in a spray or fine droplet pattern. The nozzles 458 may alternatively be configured flow coolant onto the inner plate 312 of the roof 105. At least a majority of the one or more roof spray nozzles 458 may be angled to spray coolant against the inner plate 312. The roof spray nozzles 458 may spray, mist, flow, drip, or otherwise direct the coolant from the roof spray conduits 456 onto the inner surface of the inner plate 312 for cooling the roof 105. The roof header 454 may be fluidly connected to a supply pipe and each of the roof spray conduits 458 may be fluidly connected to the roof header 454. It is to be understood that the spray cooling system 400 could include more than one supply pipe and more than one header.

FIG. 4A illustrates a portion of the spray cooling system 400 as shown in the sidewall 125 or the roof 105 having a cleanout trap 490. The cleanout trap 490 is configured to alter the characteristics, such as velocity, of the flow of the coolant in the spray cooling system 400 for removing particulate from the coolant flowing through the cleanout trap prior to the coolant flowing out of the nozzles of the spray cooling system 400. The spray cooling system 400 in the roof 105 is substantially similar to the spray cooling system 400 disposed in the sidewall 125. For example, in operation the roof header 454 operates in in the same fashion as the sidewall header pipe 424. That is, the roof header 454 and the sidewall header pipe 424 both provide coolant respectively to the sidewall branch conduits 428 in the roof 105 and the roof spray conduits 458 in the sidewall 125. For simplifying further discussion, the roof spray conduits 458 and the sidewall branch conduits 428 will be collectively referred to hereon out as spray conduits 480. Similarly, the roof header 454 and the sidewall header pipe 424 will collectively be referred to here on out as headers 470. Likewise, spray sidewall nozzles 432 and roof spray nozzles 458 will collectively be referred to here on out as spray nozzles 465. It should be understood that the headers, 470, the spray conduits 480 and the spray nozzles 465 may operate within the roof 105 and/or sidewall 125. Additionally, further components disclosed below connected or operable with the headers 470, the spray conduits 480 and the spray nozzles 465 are suitable for use in the spray cooling system 400 in the roof 105 or in the sidewall 125.

The cleanout trap 490 have an in-line configuration, for example, as shown by particle trap 491, where a flow 460 of spray coolant moves in a header 470 or spray conduit 480 of the spray cooling system 400 past the particle trap 491 when flowing to the nozzles. The particle trap 491 may be disposed in or part of the roof spray conduit 456 or the branch conduit 428, i.e., the spray conduits 480. Alternately, the particle trap 491 may be disposed in or part of the headers 470, i.e., the roof header 454 or the sidewall header 424. There may be one to many particle traps 491 in the spray cooling system 400. In one example, each branch conduit 428 (and/or roof spray conduit 456) has a dedicated particle trap 491.

The cleanout trap 490 has an inlet 475 and an outlet 476. The particle trap 491 may integrally formed with or coupled to the headers 470 or the spray conduits 480. In one example, the particle trap 491 may be a wye shaped. The particle trap 491 may have one or more couplings at the inlet 475/outlet 476 for joining the headers 470 or the spray conduits 480. The inlet 475 couples the particle trap 491 to an upstream portion 478 portion of the headers 470 or the spray conduits 480. The upstream portion 478 portion of the headers 470 or the spray conduits 480 has incoming flow 481, which enters the particle trap 491. An outlet 476 may couple the particle trap 491 to a downstream portion 479 portion of the headers 470 or the spray conduits 480. The downstream portion 479 portion of the headers 470 or the spray conduits 480 has outgoing flow 482 which leaves the particle trap 491.

The particle trap 491 has a steady flow portion 498 in-line with the headers 470 or the spray conduits 480. The inlet 475 and outlet 476 are disposed on opposite ends of the steady flow portion 498. The particle trap 491 has an eddy flow portion 499, a short pipe, branching off and fluidly coupled to the steady flow portion 498 at an angle 495. The eddy flow portion 499 coupled to the steady flow portion 498 between the inlet 475 and the outlet 476. The eddy flow portion 499 of the particle trap 491 is vertically below the steady flow portion 498. The eddy flow portion 499 is where particulate 405 is collected in the particle trap 491. The header 470 or conduit 480 may have baffle 435 therein upstream or prior to the particle trap 491. The baffle 435 is configured to substantially make the flow 460 eddy, or more turbulent, as it enters the steady flow portion 498 of the particle trap 491. The eddy in the flow 460 in the steady flow portion 498 of the particle trap 491 increases the amount of turbulence in the flow 460 and the particulate 405 removed upon the flow 460 entering the eddy flow portion 499 of the particle trap 491.

Gravity is relied on for settling the particulate 405 out of the eddy flow portion 499. To encourage particulate to precipitate out of the flow 460, the angle 495 between the upstream portion 478 portion of the headers 470 or the spray conduits 480 and the eddy flow portion 499 may be angled between about 0 degrees and about 180 degrees. In one example, the angle 495 between the eddy flow portion 499 of the particle trap 491 and the upstream portion 478 portion of the headers 470 or the spray conduits 480 and may be angled about 45 degrees. The angle 495 between the upstream portion 478 portion of the headers 470 or the spray conduits 480 and the eddy flow portion 499 may be angled between 20 degrees and 170 degrees from horizontal.

The incoming flow 481 of the spray coolant in the headers 470 or the spray conduits 480 may have suspended solids when entering the steady flow portion 498 of the particle trap 491. The incoming flow 481 is primarily steady state which enables the suspended solids to remain in the flow 460. The incoming flow 481 becomes more turbulent and forms an eddy flow 483 as portions of the flow 460 is diverted into and out of the eddy flow portion 499 by way of the angle 495. The eddy flow 483 decreases the local pressure of the flow 460, which enables particulate 405 to precipitate out of the flow 460. The particulate 405 may collect at a basin 409 of the eddy flow portion 499 of the particle trap 491. The basin 409 is at the bottom of the eddy flow portion 499 of the particle trap 491. The flow 460, after precipitating out the particulate 405, may exit the particle trap 491 as outgoing flow 482. The outgoing flow 482 may have substantially suspended solids then incoming flow 481.

A valve 419, or cap, may be coupled to or form the basin 409 of the particle trap 491. The valve 419 change between an open state and a closed state. The open state allows flow therethrough the valve 419. The closed state of the valve 419 prevents coolant from flowing through the valve 419. The valve 419 may be normally closed, or held in the closed state by the controller. A sensor 407 may be disposed in the eddy flow portion 499 of the particle tap adjacent the basin 409. The sensor 407 is configured to detect the presence of particulate 405 in the basin 409. The sensor 407 provides data to a controller, or the valve 419, which determines when the state of the valve 419 should be changed between open state to flush the particulate 405 from the eddy flow portion 499 of the particle trap through an outlet 411 in the eddy flow portion 499 or in a closed state. Alternatively, the valve 419 may be cycled on a predefined schedule, for example by using a timer, based on levels of particulate 405 detected by the sensor 407, or simply on a schedule selected without use of a sensor 407.

In yet another alternative, the particle trap 491 may have a cap attached to the basin 409 instead of the valve 419. The cap may be removed when flushing, cleaning or collecting particulate 405 from the basin 409. The particle trap 491 arranged with the cap may utilize the sensor for detecting particulate 405 in the basin 409. The cap may be unscrewed or detached from the basin 409 to remove the collected particulate. It should be a appreciated that the particle tarp 491 may utilize the cap with the basin 409 without the sensor 407. The cap can be removed during scheduled maintenance for cleaning collected particulate from the spray cooling system 400. On example for the cap is shown in FIG. 4B as item 732.

The outlet 411 may be opened manually to remove collected particulate 405. Alternately, the outlet 411 may be coupled to a separate drain for removal of the particulate from the spray cooling system 400. In this alternate configuration, the sensor 407 may detect a level of the particulate 405 disposed in the basin 409 and communicate the level of the particulate 405 in the basin 409 to a controller. The controller, upon determining the level of the particulate 405 in the basin 409 exceeds a threshold, outputs a signal to set the valve 419 to an open state, thus allowing the particulate 405 to be removed from the basin 409. In either configuration, the removal of the particulate 405 from the spray cooling system 400 prevents the clogging of the spray nozzles 465 and reduce furnace downtown for maintenance.

The cleanout trap 490 utilizes eddy flow and specific geometries to create a low pressure zone in the headers 470 or before the spray conduits 480 that allow particulate to occur. Within the headers 470 and spray conduits 480, a purposely designed cleanout trap 490 is not limited to the geometries shown. The geometries of the cleanout trap 490 can be configured depending on the available space, flow through the cleanout trap 490, type and/or size of the headers 470 and spray conduits 480 for which it is being provided. The cleanout trap 490 is oriented to generate eddy flow and/or low velocities in the headers 470 or the spray conduits 480 and collect the particulate 405 which falls out of the flow 460 through gravity. The cleanout trap 490 provide a means to flush the accumulated particulate. Furthermore, the cleanout trap 490 is suitable to operate in a pressurized water system.

FIG. 4B illustrates a portion of the spray cooling system 400 shown having another example of the cleanout trap 490. This example of the cleanout trap 490 is for another in-line type of a particle trap 791. Particle trap 791, similar to that of the particle trap 491, is connected by the inlet 475 and the outlet 476 to the headers 470 and/or the spray conduits 480.

The particle trap 791 may consist of a straight section of pipe 710 having a slot 762 formed therein. The slot 762 may be oriented in a lower portion of the straight section of pipe 710 to allow gravity to aid in particle 405 removal. The slot 762 is sized to provide fluid access to a chamber 709. A cap 732 is attached to the chamber 709. Although shown vertically below the slot 762, the cap 732 on the chamber 709 may be positioned anywhere on the chamber 709 away from the straight section of pipe 710.

The velocity of the flow 460 is slowed as the flow 460 eddies and enters in the chamber 709 allowing particulate 405 carried by the flow 460 of coolant to fall out of the flow 460 of coolant. The cap 732 may be removable for opening and closing the chamber 709. For example, securing the cap 732 to the chamber 709 allows the particulate 405 to accumulate in the chamber 709. In another example, removing the cap 732 from the chamber 709 allows the particulate 405 to be flushed from the chamber 709 and the spray cooling system 400.

FIG. 4C illustrates a portion of a spray cooling system 400 shown having yet another example of the cleanout trap 490. A particle trap 891 is provided as another suitable in-line type of cleanout trap 490. Particle trap 891, similar to that of the particle trap 491, is connected by the inlet 475 and the outlet 476 to the headers 470 and/or the spray conduits 480.

The particle trap 891 has a particulate basin 860. The particulate basin 860 is directly coupled by the inlet 475 and the outlet 476 to the headers 470 and/or the spray conduits 480. The particulate basin 860 has a cross-sectional area greater than that of the headers 470 and/or the spray conduits 480. The particulate basin 860 is sized to slow the flow 460 of the coolant. The cap 732 is attached to the particulate basin 860.

The velocity of the flow 460 is slowed as the flow 460 allowing particulate 405 carried by the flow 460 of coolant to fall out of the flow 460 of coolant due to gravity. The cap 732 may be removable for opening and closing the particulate basin 860. For example, securing the cap 732 to the particulate basin 860 allows the particulate 405 to accumulate in the particulate basin 860. In another example, removing the cap 732 from the particulate basin 860 allows the particulate 405 to be flushed from the particulate basin 860 and the spray cooling system 400.

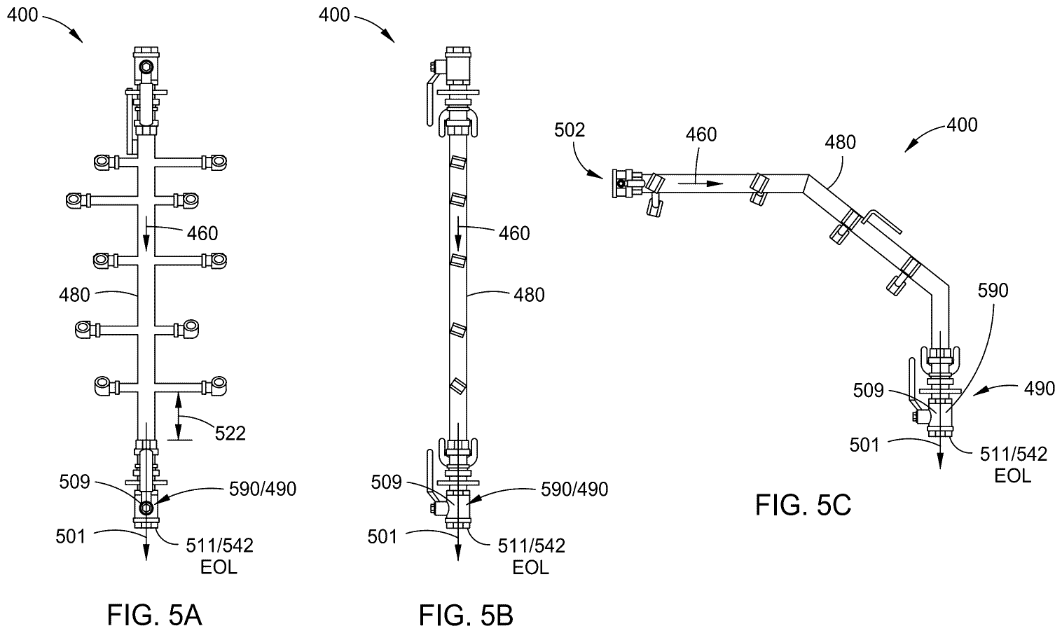

FIG. 5A-5C illustrate another portion of the spray cooling system 400 as shown in the sidewall 125 or the roof 105 having the cleanout trap 490. FIGS. 5A and 5B are just difference side views if the same pipe, while 5C is a different pipe. The cleanout trap 490 may be an end-of-line trap 591. The end-of-line trap 591 may be used alternately or in addition to the particle trap 491. The end-of-line trap 591 has a vertical, or somewhat vertical, orientation 501. The end-of-line trap 591 is installed downstream of the nozzles 432/458 and spray bars 428/456, i.e., spray conduits 480.

When static pressure increases, velocity pressure decreases. The flow 460 of coolant has to pressurizes in the pray conduits 480 due to the decreased flow as water leaves the nozzles 432/458. The velocity of the flow 460 is lower as the flow 460 of the coolant reaches the last nozzles 432/458 on the spray conduits 480. The lower velocity allows the particulate 405 to vertically fall out of the coolant under the effect of gravity. Thus, the end-of-line trap 591 having a substantially vertical orientation, as shown by arrow 501, aids in collecting the majority of the particulate 405 in the end-of-line trap 591. Although not shown, a separate drain-line may be fluidly coupled to the end-of-line trap 591 for removing collected particulate 405 for the end-of-line trap 591 and the spray cooling system 400.

FIGS. 5A and 5B illustrate the spray conduits 480 disposed in the sidewall and having a substantially vertical orientation at the cleanout trap 490. It should be appreciated that the spray conduits 480 as shown in FIG. 2 is not entirely vertical. However, it should be appreciated that fluid and particulate 405 in the spray conduit 480 in FIG. 2 would primarily flow under gravity to the end where the end-of-line trap 591 is located. That is, the spray conduits 480 includes at least some change in elevation sufficient to all particulate to collect at a vertically lower portion of the conduit 480. Thus, the end-of-line trap 591 may be aligned with the spray conduits 480 in the substantial vertical orientation.

FIG. 5C illustrates the spray conduits 480 disposed in the roof 105 and having an orientation with a substantial horizontal component as well as a vertical component. The end-of-line trap 591 may be aligned vertically with gravity after the last nozzle 458 in the spray conduit 480 in the roof 105 as shown by an offset 522. In some roofs 105, the spray conduit 480 may be extended with an elbow, sweep or other direction changing device to align the flow 460 in the end-of-line trap 591 in a substantially vertical direction to aid in the collection of the particulate 405 in the end-of-line trap 591.

In each of the spray conduits 480 shown in FIGS. 5A-5C, the particulate trap includes a valve 509 for removing the particulate 405 from the spray conduit 480. The valve 509 may be manually and/or automatically controlled. In an open state, the valve 509 allows particulate 405 to be removed from the spray conduit 480 during a cleaning, maintenance, or normal operation. When automatically controlled, the valve 509 may be operated by a controller. The controller may periodically open the valve 509 to ensure particulate 405 is removed from the spray conduit 480. Alternately, a sensor, such as that shown and described in FIG. 4A, may be disposed in the end-of-line trap 591 to provide information to the controller for determining that the amount of collected particulate 405 exceeds a predetermined threshold, upon determination of which, the controller would open the valve 509 to allow removal of the particulate 405 from the spray conduit 480. In yet other alternatives, the end-of-line trap 591 may have a cap instead of the valve 509. The cap in the end-of-line trap 591 may operate in a manner substantially the same as the cap in the particle trap 491.

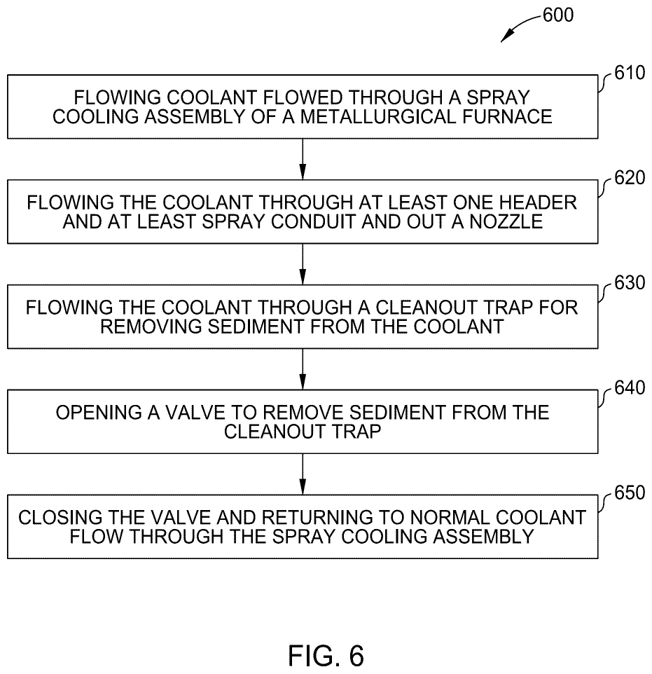

FIG. 6 illustrates a flow diagram of a method 600 for removing particulate from a spray cooling system. At a first operation 610, coolant is flowed into a spray cooling system of a metallurgical furnace. At operation 620, the coolant flows through at least one header and at least spray conduit and out a nozzle. The nozzle directs the coolant onto a hot surface of the metallurgical furnace, such as an inner plate of a sidewall and/or roof of the metallurgical furnace. The sprayed coolant is then collected by a drain for removal from the sidewall and/or roof of the metallurgical furnace. The coolant may optionally be recirculated and reused. The coolant flowing in the header and spray conduit may have suspended solids.

At operation 630, the coolant is flowed through a cleanout trap for removing particulate from the coolant prior to the coolant reaching the nozzles. The cleanout trap may be fluidly coupled to the header or spray conduit. To prevent the particulate from clogging the spray nozzles, the spray cooling system includes the clean out trap in the header or spray conduits for removing the particulate into a collection basin in the cleanout trap. The cleanout trap may be substantially oriented in a substantially vertical direction to use gravity in the removal of the particulate and have the particulate fall into the collection basin. The cleanout trap may slower the velocity of the coolant in the header or spray conduits for the particulate suspended in the coolant to fall out of the coolant flow under the forces of gravity. Alternately, or concurrently, the cleanout trap may introduce an eddy or additional turbulence to the steady flow of the coolant to encourage the particulate to settle out of the coolant flow prior to reaching the nozzles.

At operation 640, a valve is opened to remove particulate from the cleanout trap. The valve may be manually opened. Alternately, the valve may operate from instructions from a controller. The valve may alternately be coupled to a controller for changing the valve between an open state and a closed state. The controller may optionally be coupled to a sensor. The sensor detects a level of the particulate present in the collection basin portion of the cleanout trap. The controller may use the level information provided by the sensor for determining when to open the valve, how long to keep the valve open, and/or the duty cycle valve opening. In yet other alternative examples, a cap is detached from the basin of the cleanout trap to allow the removal of particulate from the basin of the cleanout trap.

At operation 650, the valve is returned in the closed state. Alternately, the cap is placed back on the cleanout trap.

In this manner, particulate can advantageously be removed by the cleanout trap from the spray cooling system of a metallurgical furnace. The collection and removal of the particulate by the cleanout trap substantially reduces the clogging of the nozzles spraying coolant for cooling the furnace walls and roof. Thus, the cleanout trap extends time between preventative and emergency maintenance and extend the operational time of the metallurgical furnace for improving operational costs.

While the foregoing is directed to embodiments of the present disclosure, other and further embodiments may be devised without departing from the basic scope thereof, and the scope thereof is determined by the claims that follow.

What is claimed is:

1. A spray cooling system for a sidewall or roof for a metallurgical furnace, the spray cooing system comprising:
a header fluidly coupled to a coolant source;
a spray conduit fluidly coupled to the header for receiving coolant flowing from the header;
one or more nozzles fluidly coupled to spray conduits, the nozzles configured to receive coolant from the spray conduit and spray, mist or otherwise direct the coolant from spray conduit onto a surface for cooling; and
a cleanout trap fluidly coupled to the spray cooling system, the cleanout trap configured to remove particulate from the coolant flowing through the cleanout trap prior to the coolant flowing through the nozzles.

2. The spray cooling system of claim 1, wherein the cleanout trap is an in-line particle trap comprising:
a steady flow portion having an inlet and an outlet; and
an eddy flow portion fluidly coupled to the steady flow portion between the inlet and the outlet.

3. The spray cooling system of claim 2, wherein the eddy flow portion is disposed at an angle vertically below the steady flow portion.

4. The spray cooling system of claim 3, wherein the eddy flow portion comprises:
a valve;
a catch basin configured to collect particulate from the flow disposed between the valve and the steady flow portion; and
an outlet disposed below the catch basin and valve, where when the valve is in an open state, fluid flows through the outlet.

5. The spray cooling system of claim 3, wherein the cleanout trap is disposed in-line with the header.

6. The spray cooling system of claim 5, wherein the header further comprises:
a baffle upstream of the cleanout trap.

7. The spray cooling system of claim 3, wherein the cleanout trap is disposed in-line the spray conduit.

8. The spray cooling system of claim 1, wherein the cleanout trap is an end of line particle trap comprising:
a valve; and
a catch basin configured to collect particulate from the flow disposed above the valve and below the steady flow portion of the cleanout trap; and
an outlet disposed below the valve, where when the valve is in an open state, fluid flows through the outlet.

9. The spray cooling system of claim 8, wherein the cleanout trap is disposed in-line with the spray conduit.

10. A sidewall for a metallurgical furnace, the sidewall comprising:
a cover plate;
a hot plate coupled in a spaced apart relation to the cover plate forming an inner volume of the sidewall, the hot plate configured to contact molten material; and
a spray cooling system disposed in the inner volume of the sidewall and configured to spray coolant on the hot plate, the spray cooling system comprising:
a header fluidly coupled to a coolant source;
a spray conduit fluidly coupled to the header for receiving coolant flowing from the header;
one or more nozzles fluidly coupled to the spray conduits, the nozzles configured to receive coolant from the spray conduit and spray, mist or otherwise direct the coolant from spray conduit onto the hot plate for cooling; and
a cleanout trap fluidly coupled to the spray cooling system, the cleanout trap configured to remove particulate from the coolant flowing through the cleanout trap prior to the coolant flowing through the nozzles.

11. The sidewall for a metallurgical furnace of claim 10, wherein the cleanout trap is an in-line particle trap comprising:
a steady flow portion having an inlet and an outlet; and
an eddy flow portion fluidly coupled to the steady flow portion between the inlet and the outlet wherein the eddy flow portion is disposed at an angle vertically below the steady flow portion, and wherein the eddy flow portion comprises:
a valve; and
a catch basin disposed between the valve and the steady flow portion and configured to collect particulate from the flow; and
an outlet disposed below the valve, where when the valve is in an open state, fluid flows through the outlet.

12. The sidewall for a metallurgical furnace of claim 11, wherein the cleanout trap is disposed in-line with the header.

13. The sidewall for a metallurgical furnace of claim 12, wherein the header further comprises:
a baffle upstream of the cleanout trap.

14. The sidewall for a metallurgical furnace of claim 11, wherein the cleanout trap is disposed in-line with spray conduit.

15. The sidewall for a metallurgical furnace of claim 10, wherein the cleanout trap is an end of line particle trap comprising:
a valve; and
a catch basin disposed between the valve and the steady flow portion of the cleanout trap, the catch basin configured to collect particulate from the flow disposed above the valve and below the steady flow portion of the cleanout trap; and
an outlet disposed below the valve, where when the valve is in an open state, fluid flows through the outlet.

16. The sidewall for a metallurgical furnace of claim 15, wherein the cleanout trap is disposed on the end of the spray conduit.

17. A roof for a metallurgical furnace having a hearth and a sidewall sitting on the hearth, the roof comprising:
a cover plate;
a hot plate coupled in a spaced apart relation to the cover plate forming an inner volume of the roof, the hot plate configured to face the inner volume; and
a spray cooled system disposed in the inner volume of the roof and configured to spray coolant on the hot plate, the spray cooled system comprising:
a header fluidly coupled to a coolant source;
a spray conduit fluidly coupled to the header for receiving coolant flowing from the header;
one or more nozzles fluidly coupled to spray conduits, the nozzles configured to receive coolant from the spray conduit and spray, mist or otherwise direct the coolant from the spray conduit onto the hot plate for cooling; and
a cleanout trap fluidly coupled to the spray cooling system, the cleanout trap configured to remove particulate from the coolant flowing through the cleanout trap prior to the coolant flowing through the nozzles.

18. The roof for a metallurgical furnace of claim 17, wherein the cleanout trap is an in-line particle trap comprising:
a steady flow portion having an inlet and an outlet; and
an eddy flow portion fluidly coupled to the steady flow portion between the inlet and the outlet wherein the eddy flow portion is disposed at an angle vertically below the steady flow portion, and wherein the eddy flow portion comprises:
a valve; and
a catch basin disposed between the valve and the steady flow portion of the cleanout trap, the catch basin configured to collect particulate from the flow; and
an outlet disposed below the valve, where when the valve is in an open state, fluid flows through the outlet.

19. The roof for a metallurgical furnace of claim 18, wherein the cleanout trap is disposed in-line with the header.

20. The roof for a metallurgical furnace of claim 17, wherein the cleanout trap is an end of line particle trap disposed on the spray conduit, the end of line trap comprising:
a valve; and
a catch basin disposed between the valve and the steady flow portion of the cleanout trap, the catch basin configured to collect particulate from the flow; and
an outlet disposed below the valve, where when the valve is in an open state, fluid flows through the outlet.
